(19) United States
(12) Patent Application Publication
(10) Pub. No.: US 2024/0334468 A1
(43) Pub. Date: Oct. 3, 2024

(54) WIRELESS COMMUNICATION SYSTEM, WIRELESS COMMUNICATION CONTROL METHOD, CONTROL DEVICE, AND CONTROL PROGRAM

(71) Applicant: NIPPON TELEGRAPH AND TELEPHONE CORPORATION, Tokyo (JP)

(72) Inventors: Shoko SHINOHARA, Musashino-shi, Tokyo (JP); Yusuke ASAI, Musashino-shi, Tokyo (JP); Yasushi TAKATORI, Musashino-shi, Tokyo (JP); Junichi IWATANI, Musashino-shi, Tokyo (JP); Tomoyuki YAMADA, Musashino-shi, Tokyo (JP); Yoshitaka SHIMIZU, Musashino-shi, Tokyo (JP)

(73) Assignee: NIPPON TELEGRAPH AND TELEPHONE CORPORATION, Tokyo (JP)

(21) Appl. No.: 18/580,165

(22) PCT Filed: Jul. 20, 2021
(86) PCT No.: PCT/JP2021/027184

§ 371 Date: Jan. 18, 2024

(51) Int. Cl. H04W 72/542; H04W 72/0446; H04W 76/20

(52) U.S. Cl. CPC H04W 72/542; H04W 72/0446; H04W 76/20

(57) ABSTRACT

A wireless communication system includes a plurality of wireless communication apparatuses forming a wireless communication network. The system also includes one or a plurality of control apparatuses that controls the plurality of wireless communication apparatuses. Each of the plurality of wireless communication apparatuses includes a plurality of network interface controllers (NICs) that performs wireless communication through different channels that do not overlap each other. The control apparatus executes channel switching processing of switching a use state of the plurality of NICs in each wireless communication apparatus. The control apparatus controls the plurality of wireless communication apparatuses to use NICs of the same channel in the same period. The control apparatus controls to share connection information regarding each of the plurality of NICs in advance before the channel switching processing.

### TECHNICAL FIELD

The present disclosure relates to a technique for controlling a wireless communication system that performs wireless communication by switching a plurality of channels.

### BACKGROUND ART

A wireless communication system including a base station and a wireless terminal is known. A typical example of the wireless communication system is a wireless local area network (LAN) for public use. As the wireless LAN for public use, for example, a use case in which data is transmitted from a base station to a wireless terminal such as a computer terminal or a smartphone terminal is assumed. Further, with the spread of Internet of Things (IT) terminals in recent years, use cases in which data is transmitted from a wireless terminal side to a base station are increasing.

In connection with wireless communication for the IoT, use of an unlicensed Sub-1 GHz band has been systematized in many countries around the world (see Non Patent Literature 1 and 2). In Japan, a 920 MHz band is allocated as a frequency band of an electronic tag system. For example, as an active electronic tag system, a low power wide area (LPWA) wireless communication system such as LoRa (registered trademark) or WiSUN (registered trademark) is known. In addition, use of IEEE 802.11ah, which is one of wireless LAN standards, has also been studied.

Since the number of frequency channels is limited in the 920 MHz band, there may be a case where wireless communication is performed while changing the channel to be used.

For example, in Japan, a total transmission time at the time of using the 920 MHz band is limited, and the total transmission time per hour needs to be within 360 seconds. Throughput is also limited because a wireless communication apparatus limits data transmission to comply with this total transmission time limit. However, for a housing of a wireless communication apparatus that switches and uses two non-overlapping channels, a total transmission time of 360 seconds per channel per hour and up to 720 seconds in total is allowed. Therefore, in order to improve the throughput, it is conceivable to perform wireless communication while changing the channel used by the housing of the wireless communication apparatus.

### CITATION LIST

### Non Patent Literature

Non Patent Literature 1: “920 MHZ-BAND TELEMETER, TELECONTROL AND DATA TRANSMISSION RADIO EQUIPMENT ARIB STANDARD”, Association of Radio Industries and Businesses, ARIB STD-T108, Version 1.3, Apr. 12, 2019 Non Patent Literature 2: “IEEE Standard for Information technology-Telecommunications and information exchange between systems Local and metropolitan area networks-Specific requirements, Part 11: Wireless LAN Medium Access Control (MAC) and Physical Layer (PHY) Specifications, Amendment 2: Sub 1 GHz License Exempt Operation”, IEEE Computer Society, IEEE Std 802.11ah TM-2016, 7 Dec. 2016.

### SUMMARY OF INVENTION

### Technical Problem

When wireless communication is performed by switching a plurality of channels, it is often necessary to restart the wireless communication apparatus at the time of channel switching. Packet loss and communication interruption during the restart of the wireless communication apparatus cause deterioration in service quality.

One object of the present disclosure is to provide a technique capable of performing wireless communication by switching a plurality of channels without restarting a wireless communication apparatus.

Another object of the present disclosure is to provide a technique capable of shortening a time required for connection processing at the time of channel switching.

### Solution to Problem

A first aspect relates to a wireless communication system.

A wireless communication system includes:
a plurality of wireless communication apparatuses that constitutes a wireless communication network; and
one or a plurality of control apparatuses that controls the plurality of wireless communication apparatuses.

Each of the plurality of wireless communication apparatuses includes a plurality of network interface controllers that performs wireless communication through different channels that do not overlap each other.

The one or plurality of control apparatuses executes channel switching processing of switching a use state of the plurality of network interface controllers in each of the plurality of wireless communication apparatuses.

The one or plurality of control apparatuses controls the plurality of wireless communication apparatuses to use the network interface controllers of the same channel in the same period.

The one or plurality of control apparatuses controls the plurality of wireless communication apparatuses to share connection information regarding each of the plurality of network interface controllers in advance before the channel switching processing.

The plurality of wireless communication apparatuses is connected to each other via network interface controllers to be used on the basis of the connection information acquired in advance.

A second aspect relates to a wireless communication control method for controlling a plurality of wireless communication apparatuses constituting a wireless communication network.

Each of the plurality of wireless communication apparatuses includes a plurality of network interface controllers that performs wireless communication through different channels that do not overlap each other.

A wireless communication control method including:
channel switching processing of switching a use state of the plurality of network interface controllers in each of the plurality of wireless communication apparatuses;
processing of controlling the plurality of wireless communication apparatuses to use network interface controllers of the same channel in the same period;
processing of controlling the plurality of wireless communication apparatuses to share connection information regarding each of the plurality of network interface controllers in advance before the channel switching processing; and
processing of connecting the plurality of wireless communication apparatuses to each other via network interface controllers to be used on the basis of the connection information acquired in advance.

A third aspect relates to a control apparatus for controlling a plurality of wireless communication apparatuses constituting a wireless communication network.

Each of the plurality of wireless communication apparatuses includes a plurality of network interface controllers that performs wireless communication through different channels that do not overlap each other.

The control apparatus includes a processor.

The processor executes channel switching processing of switching a use state of the plurality of network interface controllers in each of the plurality of wireless communication apparatuses.

The processor controls the plurality of wireless communication apparatuses to use the network interface controllers of the same channel in the same period.

The processor controls the plurality of wireless communication apparatuses to share connection information regarding each of the plurality of network interface controllers in advance before the channel switching processing.

The plurality of wireless communication apparatuses is connected to each other via network interface controllers to be used on the basis of the connection information acquired in advance.

A fourth aspect relates to a control program executed by a computer. The control program causes a computer to execute the wireless communication control method according to the second aspect described above. Alternatively, the control program causes a computer to achieve the control apparatus according to the third aspect described above.

### Advantageous Effects of Invention

According to the present disclosure, it is possible to perform wireless communication by switching a plurality of channels without restarting a wireless communication apparatus. Since it is not necessary to restart the wireless communication apparatus, the time required for channel switching, that is, the time until communication is resumed is shortened. Thus, packet loss and communication interruption time are reduced, and throughput is increased. In addition, deterioration in service quality is also prevented.

Further, according to the present disclosure, the connection information regarding each network interface controller is shared before the channel switching processing. Therefore, the time required for the connection processing at the time of channel switching is shortened.

### BRIEF DESCRIPTION OF DRAWINGS

FIG. 1 is a block diagram schematically illustrating a configuration example of a wireless communication system according to an embodiment of the present disclosure.

FIG. 2 is a conceptual diagram for describing an example of channel switching processing (NIC switching processing) in the wireless communication system according to the embodiment of the present disclosure.

FIG. 3 is a block diagram illustrating a configuration example of the wireless communication apparatus according to the embodiment of the present disclosure.

FIG. 4 is a block diagram illustrating a configuration example of a control apparatus according to the embodiment of the present disclosure.

FIG. 5 is a flowchart for describing a first example of the channel switching processing (NIC switching processing) according to the embodiment of the present disclosure.

FIG. 6 is a flowchart for describing the first example of the channel switching processing (NIC switching processing) according to the embodiment of the present disclosure.

FIG. 7 is a flowchart for describing a second example of the channel switching processing (NIC switching processing) according to the embodiment of the present disclosure.

FIG. 8 is a flowchart for describing the second example of the channel switching processing (NIC switching processing) according to the embodiment of the present disclosure.

FIG. 9 is a flowchart for describing a third example of the channel switching processing (NIC switching processing) according to the embodiment of the present disclosure.

FIG. 10 is a flowchart for describing the third example of the channel switching processing (NIC switching processing) according to the embodiment of the present disclosure.

FIG. 11 is a flowchart for describing a fourth example of the channel switching processing (NIC switching processing) according to the embodiment of the present disclosure.

FIG. 12 is a flowchart for describing the fourth example of the channel switching processing (NIC switching processing) according to the embodiment of the present disclosure.

FIG. 13 is a flowchart for describing a fifth example of the channel switching processing (NIC switching processing) according to the embodiment of the present disclosure.

FIG. 14 is a flowchart for describing the fifth example of the channel switching processing (NIC switching processing) according to the embodiment of the present disclosure.

FIG. 15 is a flowchart illustrating an example of connection information sharing processing in the wireless communication system according to the embodiment of the present disclosure.

FIG. 16 is a flowchart illustrating general connection processing.

FIG. 17 is a flowchart illustrating an example of connection processing according to the embodiment of the present disclosure.

FIG. 18 is a block diagram schematically illustrating another configuration example of the wireless communication system according to the embodiment of the present disclosure.

FIG. 19 is a conceptual diagram for describing an example of the channel switching processing (NIC switching processing) and limited communication processing in the wireless communication system according to the embodiment of the present disclosure.

FIG. 20 is a flowchart for describing the limited communication processing according to the embodiment of the present disclosure.

### DESCRIPTION OF EMBODIMENTS

An embodiment of the present disclosure will be described with reference to the accompanying drawings.

### 1. Overview of Wireless Communication System

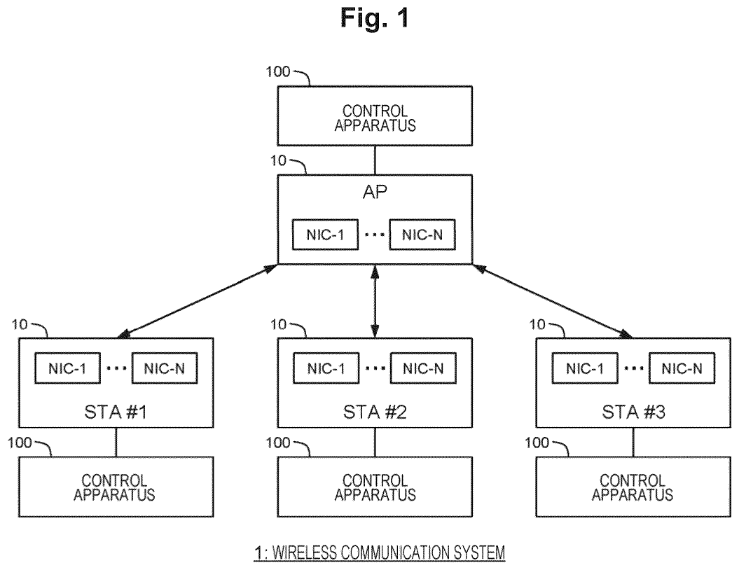

FIG. 1 is a block diagram schematically illustrating a configuration example of a wireless communication system 1 according to the present embodiment. The wireless communication system 1 includes a plurality of wireless communication apparatuses 10 constituting a wireless communication network.

For example, the plurality of wireless communication apparatuses 10 includes a base station (master) and one or more wireless terminals. The base station and the one or more wireless terminals constitute a wireless communication network and perform wireless communication with each other. For example, the wireless communication system 1 is a wireless LAN system, and the base station is an access point of the wireless LAN. A cell including an access point and one or more wireless terminals is referred to as a basic service set (BSS). Note that, in the description below, for the sake of simplicity, the base station is referred to as an “AP”, and the wireless terminal is referred to as a “STA”.

The wireless communication system 1 performs wireless communication using, for example, an unlicensed Sub-1 GHz band. For example, the wireless communication system 1 performs wireless communication using the 920 MHZ band.

The wireless communication system 1 according to the present embodiment can perform wireless communication by switching a plurality of channels (frequency channels). That is, the wireless communication apparatus 10 can perform wireless communication by switching a plurality of channels. The processing of switching the channel to be used in the wireless communication apparatus 10 is hereinafter referred to as “channel switching processing”.

According to the present embodiment, a plurality of network interface controllers (network interface cards) is used in the channel switching processing. In the description below, the network interface controller is referred to as a “NIC” for simplicity. In order to distinguish a plurality of NICs, a branch number such as “NIC-i” is used.

In the example illustrated in FIG. 1, each wireless communication apparatus 10 (AP, STA) includes a plurality of NICs (NIC-1 to NIC-N). Herein, N is an integer of 2 or more. For example, N is two. The plurality of NICs (NIC-1 to NIC-N) is set to perform wireless communication through different channels CH-1 to CH-N that do not overlap each other. Therefore, the channel used for the wireless communication can be switched by switching the use state of the plurality of NICs (NIC-1 to NIC-N). In other words, the channel used for the wireless communication can be switched by switching the NIC to be used among the plurality of NICs (NIC-1 to NIC-N). The NIC to be selectively used among the plurality of NICs (NIC-1 to NIC-N) is hereinafter referred to as a “selected NIC”. The “selected NIC” can also be referred to as a “used NIC”, an “active NIC”, or the like. It can also be said that the channel switching processing is “NIC switching processing” of switching the selected NIC among the plurality of NICs (NIC-1 to NIC-N).

The wireless communication system 1 according to the present embodiment further includes one or a plurality of control apparatuses 100 that controls the plurality of wireless communication apparatuses 10 (AP, STA). In particular, the one or plurality of control apparatuses 100 manages and controls the channel switching processing (NIC switching processing) described above.

In the example illustrated in FIG. 1, a plurality of control apparatuses 100 is connected to each of the plurality of wireless communication apparatuses 10. For example, the plurality of control apparatuses 100 respectively controls the plurality of wireless communication apparatuses 10 in synchronization with each other. In addition, not only the plurality of control apparatuses 100 can respectively control the plurality of wireless communication apparatuses 10, but also a single control apparatus 100 can control all of the plurality of wireless communication apparatuses 10. For example, the control apparatus 100 connected to the AP may control the AP and each STA.

The control apparatus 100 is not necessarily connected to the outside of the wireless communication apparatus 10. The function of the control apparatus 100 may be included in each wireless communication apparatus 10. For example, each wireless communication apparatus 10 executes a control program and achieves the function of the control apparatus 100. In this case, the wireless communication apparatus 10 that executes the control program corresponds to the control apparatus 100.

In the description below, the one or plurality of control apparatuses 100 and the control program that manage and control the channel switching processing are collectively referred to as the “control apparatus 100” or the “control function”.

The control apparatus 100 (control function) according to the present embodiment executes the channel switching processing of switching the use state of the plurality of NICs (NIC-1 to NIC-N) in each of the plurality of wireless communication apparatuses 10. In other words, the control apparatus 100 (control function) executes the channel switching processing of switching the selected NIC in each of the plurality of wireless communication apparatuses 10 among the plurality of NICs (NIC-1 to NIC-N). Further, the control apparatus 100 collectively controls the plurality of wireless communication apparatuses 10 so that the plurality of wireless communication apparatuses 10 uses the selected NICs of the same channel in the same period. It is possible to efficiently execute the channel switching processing by collectively controlling the plurality of wireless communication apparatuses 10.

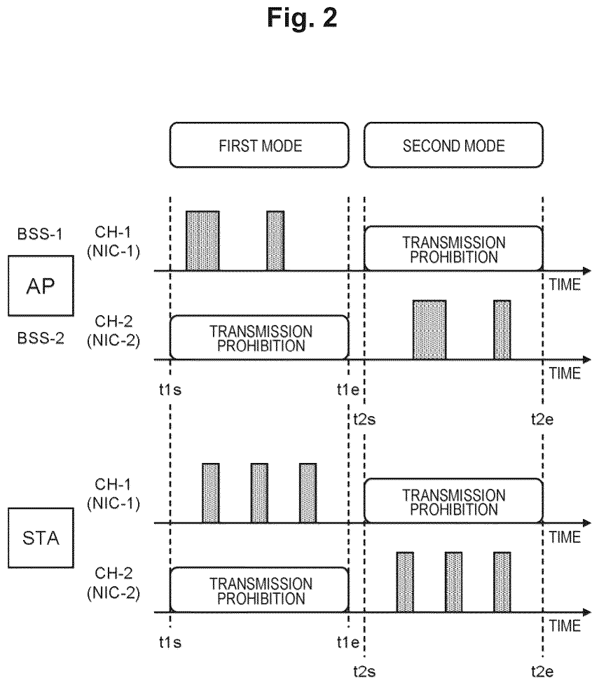

FIG. 2 is a conceptual diagram for describing an example of the channel switching processing (NIC switching processing) according to the present embodiment. The AP includes an NIC-1 that performs wireless communication through a first channel CH-1 and an NIC-2 that performs wireless communication through a second channel CH-2 different from the first channel CH-1. Similarly, the STA includes an NIC-1 that performs wireless communication through a first channel CH-1 and an NIC-2 that performs wireless communication through a second channel CH-2 different from the first channel CH-1.

In a first period from time t1s to time t1e, the control apparatus 100 sets a first mode. Specifically, the control apparatus 100 sets the NIC-1 as a selected NIC in each of the AP and the STA. The AP and the STA constitute BSS-1, and both perform wireless communication using the NIC-1. In addition, the control apparatus 100 basically prohibits data transmission using the NIC-2 other than the selected NIC (NIC-1) in each of the AP and the STA. That is, for the NIC-2 other than the selected NIC, the first period from time t1s to time t1e is a “transmission prohibition period”. In the transmission prohibition period, data reception is possible, but data transmission is prohibited. As a modification, only transmission of a specific radio frame (for example, a response frame (ACK) in response to reception of an uplink frame) may be allowed even during the transmission prohibition period.

In a second period from time t2s to time t2e, the control apparatus 100 sets a second mode. Specifically, the control apparatus 100 sets the NIC-2 as a selected NIC in each of the AP and the STA. The AP and the STA constitute BSS-2, and both perform wireless communication using the NIC-2. In addition, the control apparatus 100 basically prohibits data transmission using the NIC-1 other than the selected NIC (NIC-2) in each of the AP and the STA. That is, for the NIC-1 other than the selected NIC, the second period from time t2s to time t2e is a “transmission prohibition period”. In the transmission prohibition period, data reception is possible, but data transmission is prohibited. As a modification, only transmission of a specific radio frame (for example, a response frame (ACK) in response to reception of an uplink frame) may be allowed even during the transmission prohibition period.

Note that, in a period between the first mode and the second mode (time t1e to time t2s), module switching or the like is performed.

The control apparatus 100 alternately performs the setting of the first mode and the setting of the second mode, thereby switching the selected NIC (used channel). In other words, the control apparatus 100 switches the NIC-1 and the NIC-2 so that the data transmission times do not overlap. It can also be said that the control apparatus 100 switches the BSS-1 and the BSS-2 so that the data transmission times do not overlap.

As described above, according to the present embodiment, each of the plurality of wireless communication apparatuses 10 includes the plurality of NICs (NIC-1 to NIC-N) that performs wireless communication through different channels that do not overlap each other. The control apparatus 100 executes the channel switching processing of switching the selected NIC in each wireless communication apparatus 10 among the plurality of NICs (NIC-1 to NIC-N). Further, the control apparatus 100 controls the plurality of wireless communication apparatuses 10 to use the selected NICs of the same channel in the same period.

The restart of the wireless communication apparatuses 10 is unnecessary for the switching of the NIC. Accordingly, it is possible to perform wireless communication by switching a plurality of channels without restarting the wireless communication apparatuses 10. Since it is not necessary to restart the wireless communication apparatuses 10, the time required for channel switching, that is, the time until communication is resumed is shortened. Thus, packet loss and communication interruption time are reduced, and throughput is increased. In addition, deterioration in service quality is also prevented.

Note that, as communication between upper layers, for example, it is conceivable to apply a virtualization technology of a plurality of communication paths such as multipath TCP to a plurality of NICs. Packet loss can be complemented in a transport layer, and service quality can be maintained.

### 2. Configuration Example

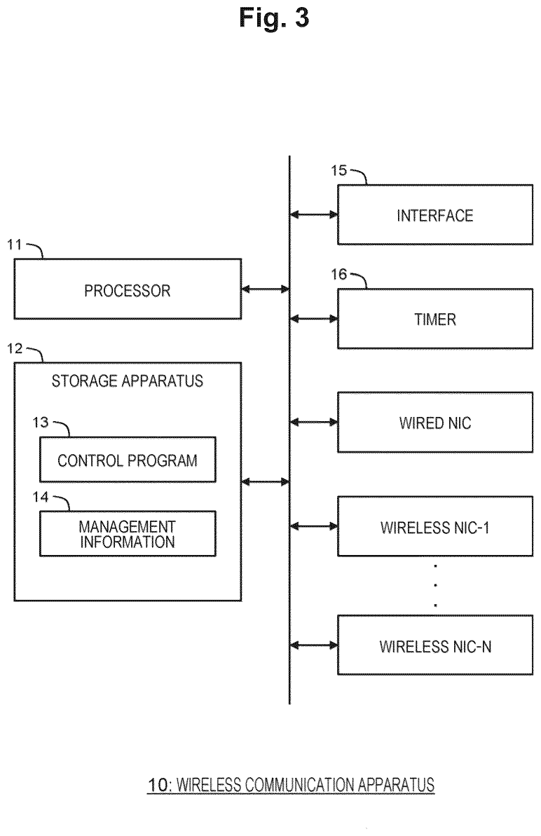

FIG. 3 is a block diagram illustrating a configuration example of the wireless communication apparatus 10 (AP, STA) according to the present embodiment. The wireless communication apparatus 10 includes one or a plurality of processors 11, one or a plurality of storage apparatuses 12, a wired NIC, and a plurality of wireless NICs (NIC-1 to NIC-N).

The processor 11 performs various types of information processing. For example, the processor 11 includes a central processing unit (CPU). The storage apparatus 12 stores various types of information necessary for processing by the processor 11. Examples of the storage apparatus 12 include volatile memory, non-volatile memory, a hard disk drive (HDD), a solid state drive (SSD), and the like.

A control program 13 is a computer program executed by the processor 11 (computer). The processor 11 executes the control program 13 to achieve the functions of the wireless communication apparatus 10. The control program 13 is stored in the storage apparatus 12. The control program 13 may be recorded on a computer-readable recording medium. The control program 13 may be provided to the wireless communication apparatus 10 via a network. Note that the processor 11 that executes the control program 13 corresponds to the control apparatus 100 that controls the wireless communication apparatus 10.

Management information 14 includes at least information used for management and control of the above-described channel switching processing. For example, the management information 14 includes a network identifier (BSSID), a channel, a switching timing, and the like regarding each NIC. The management information 14 may include the total transmission time for each NIC. The management information 14 is stored in the storage apparatus 12.

Further, the wireless communication apparatus 10 may include an interface 15 for operation from the outside. For example, the interface 15 is connected to an external control apparatus 100. The interface 15 may include a user interface.

Further, the wireless communication apparatus 10 may include a timer 16 for managing the timing of channel switching (NIC switching).

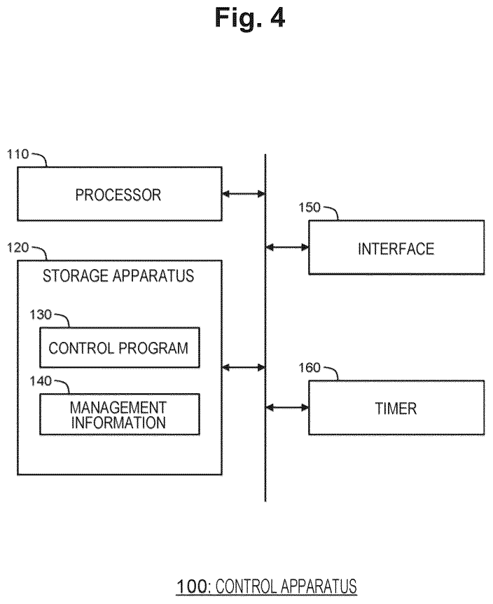

FIG. 4 is a block diagram illustrating a configuration example of the control apparatus 100 according to the present embodiment. The control apparatus 100 includes one or a plurality of processors 110 and one or a plurality of storage apparatuses 120.

The processor 110 performs various types of information processing. For example, the processor 110 includes a CPU. The storage apparatus 120 stores various types of information necessary for processing by the processor 110. Examples of the storage apparatus 120 include volatile memory, non-volatile memory, an HDD, an SSD, and the like.

A control program 130 is a computer program executed by the processor 110 (computer). The processor 110 executes the control program 130 to achieve the functions of the control apparatus 100. The control program 130 is stored in the storage apparatus 120. The control program 130 may be recorded on a computer-readable recording medium. The control program 130 may be provided to the control apparatus 100 via a network.

Management information 140 includes information used for management and control of the above-described channel switching processing. For example, the management information 140 includes a network identifier (BSSID), a channel, a switching timing, and the like regarding each NIC of each wireless communication apparatus 10. The management information 140 may include the total transmission time for each NIC. The management information 140 is stored in the storage apparatus 120.

Further, the control apparatus 100 may include an interface 150. For example, the interface 150 is connected to the wireless communication apparatus 10. The interface 150 may include a user interface.

Further, the control apparatus 100 may include a timer 160 for managing the timing of channel switching (NIC switching).

### 3. Various Examples of Channel Switching Processing

Hereinafter, various examples of the channel switching processing (NIC switching processing) according to the present embodiment will be described.

### 3-1. First Example

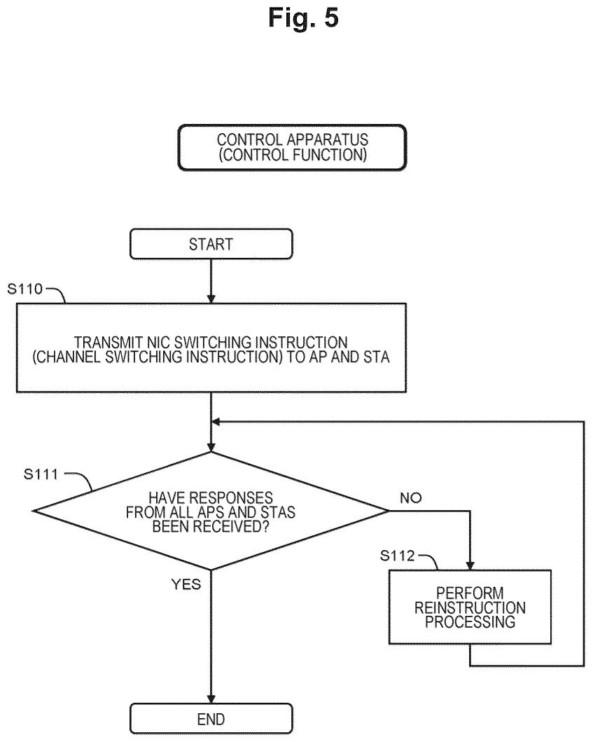

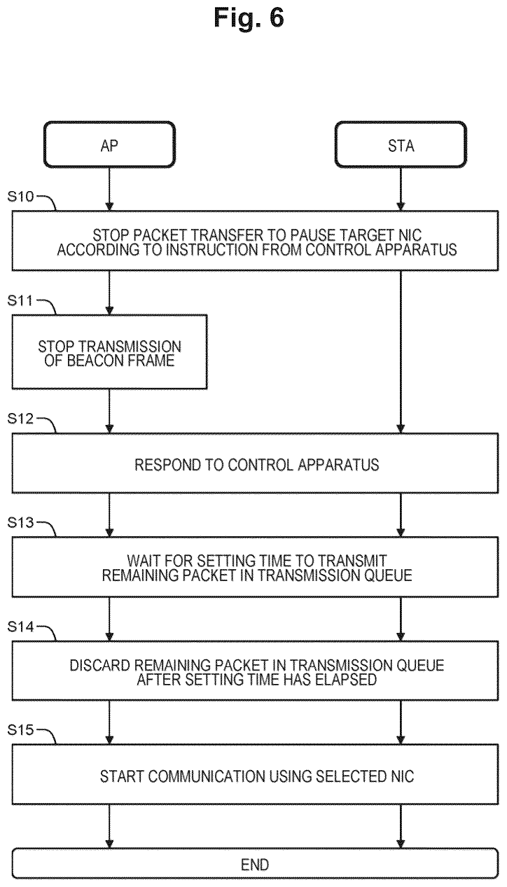

In the first example of the channel switching processing, the control apparatus 100 controls each wireless communication apparatus 10 (AP, STA) to stop the packet transfer from the upper layer to the NIC other than the selected NIC. Hereinafter, the first example of the channel switching processing will be described with reference to FIGS. 5 and 6.

FIG. 5 illustrates a processing flow by the control apparatus 100 (control function).

In step S110, the control apparatus 100 (for example, the AP-side control apparatus 100) recognizes the NIC switching timing on the basis of the management information 140. At the NIC switching timing, the control apparatus 100 transmits an NIC switching instruction (channel switching instruction) to the AP and each STA. The NIC switching instruction at least instructs to stop the packet transfer to a “pause target NIC”. Here, the pause target NIC is a selected NIC used before the NIC switching timing, and enters the transmission prohibition period after the NIC switching timing.

In step S111, the control apparatus 100 determines whether responses to the NIC switching instruction have been received from all the wireless communication apparatuses 10. In step S112, the control apparatus 100 transmits the NIC switching instruction again to the wireless communication apparatus 10 from which the response has not yet been received.

Note that, in a case where the number of STAs is very large, the NIC switching instruction may be issued in advance in consideration of the time until the instruction (notification) to all the STAs is completed.

Alternatively, in a case where the number of STAs is very large, the NIC switching timing may be determined in advance, and notification of the NIC switching timing may be given in advance at the time of starting the BSS.

FIG. 6 illustrates a processing flow by each wireless communication apparatus 10 (AP, STA).

In step S10, the wireless communication apparatus 10 receives the NIC switching instruction from the control apparatus 100. In response to the NIC switching instruction, the wireless communication apparatus 10 stops the packet transfer from the upper layer to the pause target NIC. Here, the upper layer is a layer higher than the NIC, and examples thereof include a transport layer and an application layer. By controlling the destination from such an upper layer, the packet transfer to the pause target NIC can be stopped. As another example, a function of controlling Time Fairness provided in a wireless LAN controller may be applied to limit packets allocated to the pause target NIC.

In step S11, the AP stops the transmission of a beacon frame from the pause target NIC. Normally, the beacon frame is also transmitted when there is no packet transfer from the upper layer. In the present example, during the transmission prohibition period, the transmission of such a beacon frame is also stopped. For example, a setting value of a beacon transmission interval is set to a sufficiently large value.

In step S12, the wireless communication apparatus 10 returns a response to the control apparatus 100.

In step S13, the wireless communication apparatus 10 waits for a setting time to transmit the packet remaining in the transmission queue of the wireless module of the pause target NIC. For example, when the transmission queue has a capacity of 200 packets, and the transmission time of one packet is 10 ms, the waiting time is set to 2 seconds. When the remaining packet quantity is less than the transmission queue capacity, the waiting time may be set to a shorter time.

However, when all the STAs wait for packet communication of some STAs, the overall communication efficiency decreases. In addition, it is difficult to accurately grasp the situation in the transmission queue in real time. Therefore, after the setting time has elapsed, the wireless communication apparatus 10 discards the remaining packet in the transmission queue of the pause target NIC (step S14).

In step S15, the wireless communication apparatus 10 starts the packet transfer from the upper layer to a selected NIC to be used next. Then, the wireless communication apparatus 10 starts communication using the selected NIC.

Note that the STA first maintains the state of being in association with the AP. For this purpose, the STA sets BSSMaxIdlePeriod (the time during which the connection relationship is not timed out due to the absence of the BSS) to a time sufficiently longer than the transmission prohibition period. For example, when NIC switching is performed once every 30 minutes, a sufficiently long time is several hours. Thus, the connection relationship with the AP can be maintained even when the communication in the BSS is not performed for a long time. When the channel switching is not performed periodically, the BSSMaxIdlePeriod may be set to a long period (for example, several years). In IEEE 802.11ah, there is a unified scaling factor (USF), and it is possible to maintain a long-term (up to several years) connection relationship.

### 3-2. Second Example

In the second example of the channel switching processing, the control apparatus 100 controls each wireless communication apparatus 10 (AP, STA) to stop the operation of an NIC other than a selected NIC.

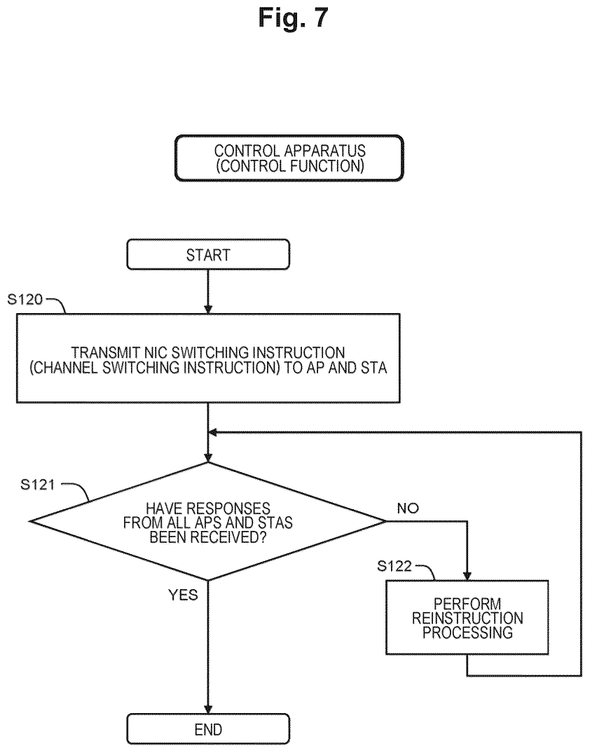

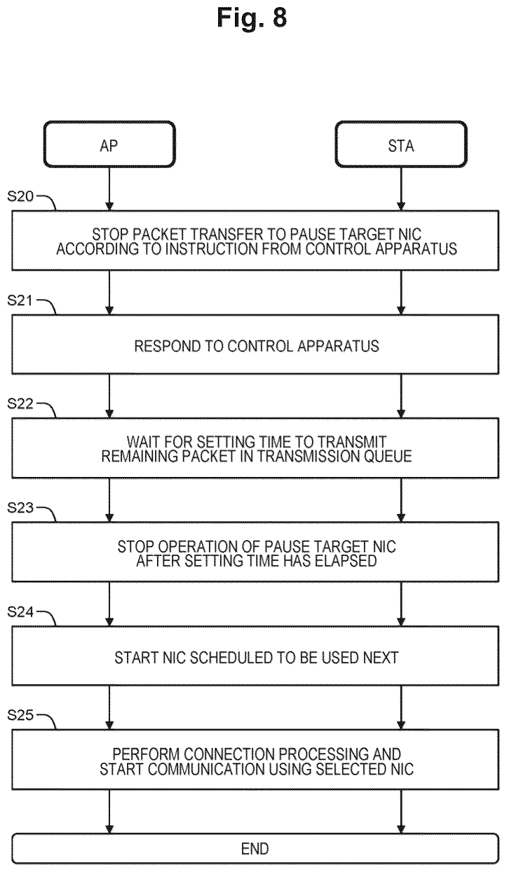

Hereinafter, the second example of the channel switching processing will be described with reference to FIGS. 7 and 8.

FIG. 7 illustrates a processing flow by the control apparatus 100 (control function).

In step S120, the control apparatus 100 (for example, the AP-side control apparatus 100) recognizes the NIC switching timing on the basis of the management information 140. At the NIC switching timing, the control apparatus 100 transmits an NIC switching instruction (channel switching instruction) to the AP and each STA. This step S120 is similar to step S110 in the first example.

In step S121, the control apparatus 100 determines whether responses to the NIC switching instruction have been received from all the wireless communication apparatuses 10. In step S122, the control apparatus 100 transmits the NIC switching instruction again to the wireless communication apparatus 10 from which the response has not yet been received.

FIG. 8 illustrates a processing flow by each wireless communication apparatus 10 (AP, STA).

In step S20, the wireless communication apparatus 10 receives the NIC switching instruction from the control apparatus 100. In response to the NIC switching instruction, the wireless communication apparatus 10 stops the packet transfer from the upper layer to the pause target NIC. This step S20 is similar to step S10 in the first example.

In step S21, the wireless communication apparatus 10 returns a response to the control apparatus 100.

In step S22, the wireless communication apparatus 10 waits for a setting time in order to transmit the packet remaining in the transmission queue of the wireless module of the pause target NIC. This step S22 is similar to step S13 in the first example.

After the setting time has elapsed, the wireless communication apparatus 10 stops the operation of the pause target NIC (step S23). The stop state may be a temporary sleep state or a complete OFF state.

In step S24, the wireless communication apparatus 10 starts an NIC scheduled to be used next. The started NIC is the selected NIC.

In step S25, the AP and the STA perform connection processing with each other through a new channel. Then, the AP and the STA start the packet transfer from the upper layer to the selected NIC, and start communication using the selected NIC.

### 3-3. Third Example

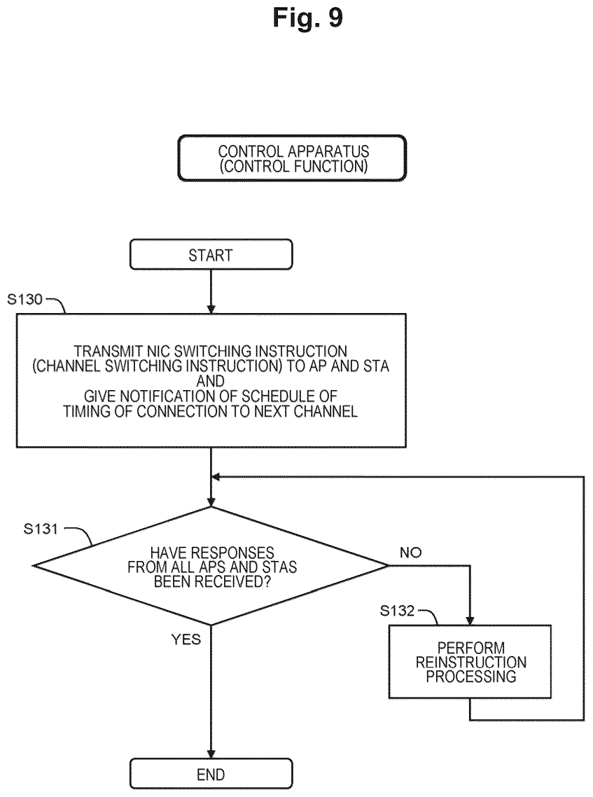

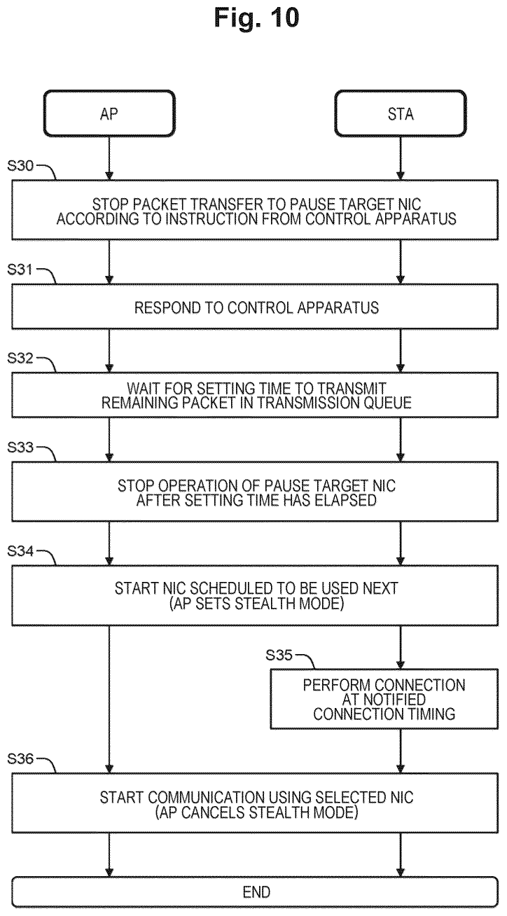

The third example of the channel switching processing is a modification of the second example described above. In the third example, the timing of connection to a next channel is explicitly specified. Hereinafter, the third example of the channel switching processing will be described with reference to FIGS. 9 and 10.

FIG. 9 illustrates a processing flow by the control apparatus 100 (control function).

In step S130, the control apparatus 100 (for example, the AP-side control apparatus 100) recognizes the NIC switching timing on the basis of the management information 140. At the NIC switching timing, the control apparatus 100 transmits an NIC switching instruction (channel switching instruction) to the AP and each STA. Further, the control apparatus 100 notifies the AP and each STA of a schedule of the timing of connection to the next channel.

In step S131, the control apparatus 100 determines whether responses to the NIC switching instruction have been received from all the wireless communication apparatuses 10. In step S132, the control apparatus 100 transmits the NIC switching instruction again to the wireless communication apparatus 10 from which the response has not yet been received.

FIG. 10 illustrates a processing flow by each wireless communication apparatus 10 (AP, STA).

In step S30, the wireless communication apparatus 10 receives the NIC switching instruction from the control apparatus 100. In response to the NIC switching instruction, the wireless communication apparatus 10 stops the packet transfer from the upper layer to the pause target NIC. This step S20 is similar to step S10 in the first example.

In step S31, the wireless communication apparatus 10 returns a response to the control apparatus 100.

In step S32, the wireless communication apparatus 10 waits for a setting time in order to transmit the packet remaining in the transmission queue of the wireless module of the pause target NIC. This step S32 is similar to step S13 in the first example.

After the setting time has elapsed, the wireless communication apparatus 10 stops the operation of the pause target NIC (step S33). The stop state may be a temporary sleep state or a complete OFF state.

In step S34, the wireless communication apparatus 10 starts an NIC scheduled to be used next. The started NIC is the selected NIC. At this time, the AP starts the NIC scheduled to be used next in a stealth mode. In the stealth mode, the AP does not notify the surroundings of its own BSSID in a beacon frame. By utilizing the stealth mode, inter-frame collisions can be reduced and connections from unscheduled STAs can be avoided.

In step S35, the STA starts connection processing to the AP at the connection timing notification of which has been given from the control apparatus 100.

When all scheduled connection processing is completed, the AP cancels the stealth mode. Then, the AP and the STA start the packet transfer from the upper layer to the selected NIC, and start communication using the selected NIC (step S36).

### 3-4. Fourth Example

In the fourth example of the channel switching processing, Target Wake Time (TWT) is used. The TWT is a technology in which a sleep period is negotiated between the AP and the STA in advance and communication is stopped during the sleep period, so that power saving and frame collision avoidance can be expected. The control apparatus 100 can control each wireless communication apparatus 10 (AP, STA) to set a sleep period (transmission prohibition period) with respect to an NIC other than a selected NIC on the basis of the TWT.

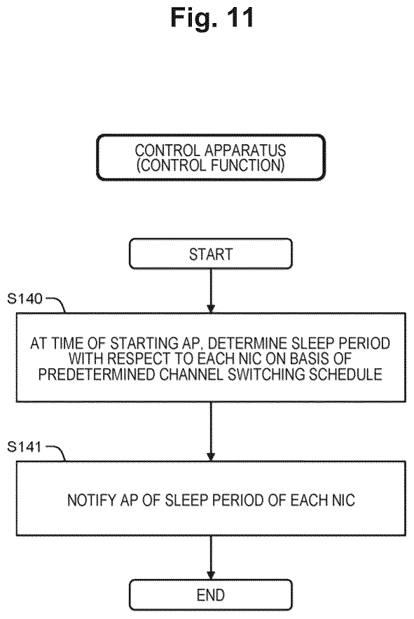

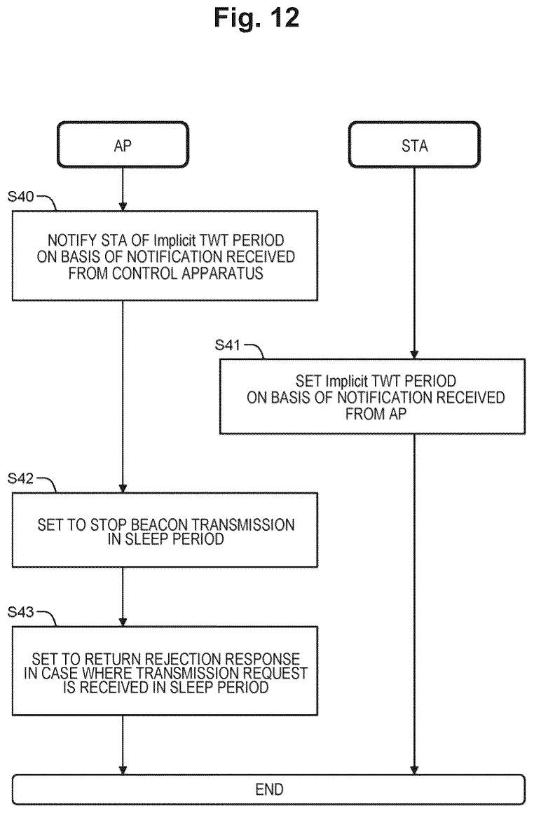

There are two types of TWT: Implicit TWT and Explicit TWT. Implicit TWT is a method in which a schedule is determined in advance. On the other hand, Explicit TWT is a method of giving notification of the schedule each time. In the fourth example, Implicit TWT is used. Hereinafter, the fourth example of the channel switching processing will be described with reference to FIGS. 11 and 12.

FIG. 11 illustrates a processing flow by the control apparatus 100 (control function).

At the time of starting the AP, the control apparatus 100 (for example, the AP-side control apparatus 100) determines a sleep period with respect to the NIC of each channel on the basis of a predetermined channel switching schedule (step S140). Then, the control apparatus 100 notifies the AP of the determined sleep period of each NIC (step S141).

FIG. 12 illustrates a processing flow by each wireless communication apparatus 10 (AP, STA).

In step S40, the AP sets an Implicit TWT period on the basis of the notification received from the control apparatus 100 so that transmission times of the channels (NICs) do not overlap. In addition, the AP notifies each STA of the Implicit TWT period. As a TWT period notification method (AP-STA negotiation method), there are methods of negotiation for each individual terminal and negotiation by broadcast, and any supportable method is used.

In step S41, each STA sets an Implicit TWT period with respect to the NIC of each channel on the basis of the notification received from the AP.

In step S42, the AP sets to stop the transmission of the beacon frame from the NIC that enters the sleep period. For example, a setting value of a beacon transmission interval is set to a sufficiently large value.

In step S43, the AP sets to return a rejection response in a case where the STA erroneously sends a transmission request during the sleep period.

Note that the available functions are not limited to TWT. Another sleep function or an access restriction function such as Restricted Access Window (RAW) may be used. In general, the control apparatus 100 controls each wireless communication apparatus 10 (AP, STA) to set the transmission prohibition period with respect to an NIC other than a selected NIC on the basis of the sleep function or the access restriction function of the wireless communication system 1.

### 3-5. Fifth Example

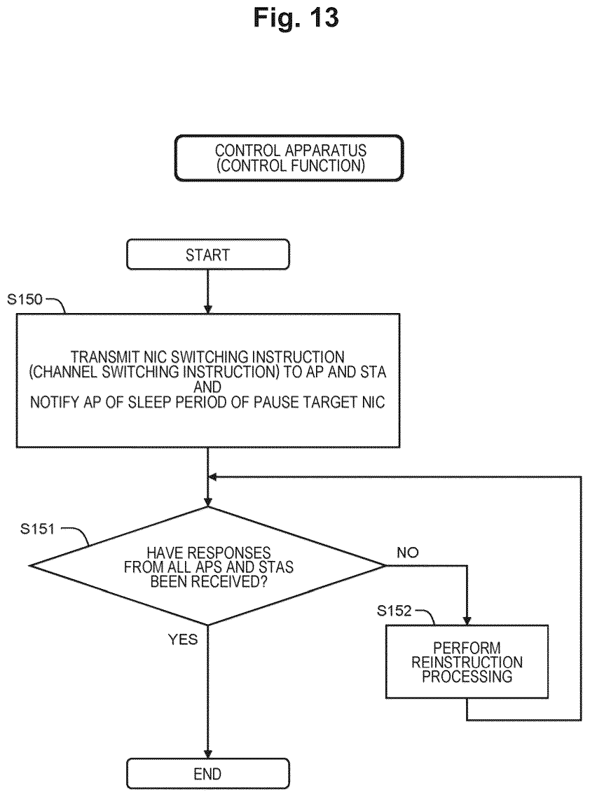

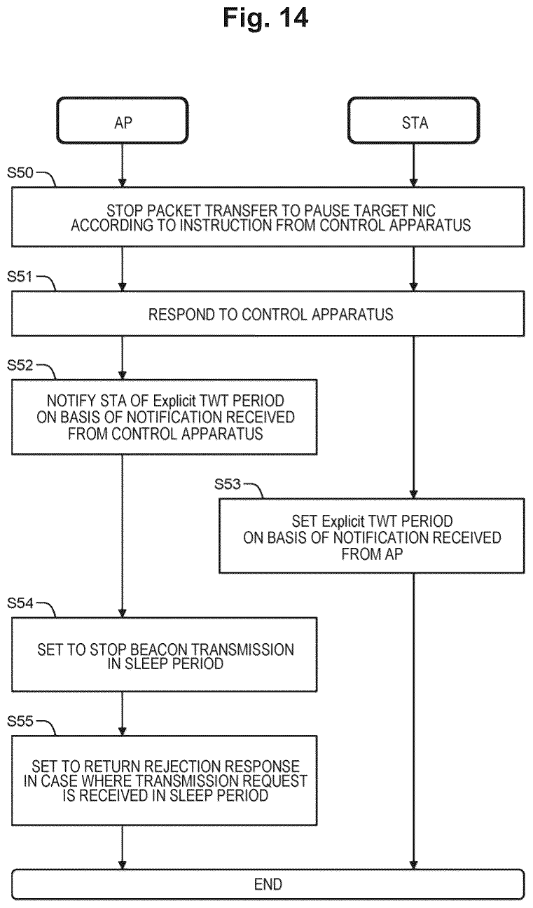

In the fifth example of the channel switching processing, Explicit TWT is used. Hereinafter, the fifth example of the channel switching processing will be described with reference to FIGS. 13 and 14.

FIG. 13 illustrates a processing flow by the control apparatus 100 (control function).

In step S150, the control apparatus 100 (for example, the AP-side control apparatus 100) recognizes the NIC switching timing on the basis of the management information 140. At the NIC switching timing, the control apparatus 100 transmits an NIC switching instruction (channel switching instruction) to the AP and each STA. Further, the control apparatus 100 determines the sleep period of the pause target NIC, and notifies the AP of the sleep period of the pause target NIC.

In step S151, the control apparatus 100 determines whether responses to the NIC switching instruction have been received from all the wireless communication apparatuses 10. In step S152, the control apparatus 100 transmits the NIC switching instruction again to the wireless communication apparatus 10 from which the response has not yet been received.

FIG. 14 illustrates a processing flow by each wireless communication apparatus 10 (AP, STA).

In step S50, the wireless communication apparatus 10 receives the NIC switching instruction from the control apparatus 100. In response to the NIC switching instruction, the wireless communication apparatus 10 stops the packet transfer from the upper layer to the pause target NIC. This step S50 is similar to step S10 in the first example.

In step S51, the wireless communication apparatus 10 returns a response to the control apparatus 100.

In step S52, the AP sets an Explicit TWT period on the basis of the notification received from the control apparatus 100 so that transmission times of the channels (NICs) do not overlap. In addition, the AP notifies each STA of the Explicit TWT period. As a TWT period notification method (AP-STA negotiation method), there are methods of negotiation for each individual terminal and negotiation by broadcast, and any supportable method is used.

In step S53, each STA sets an Explicit TWT period with respect to the NIC of each channel on the basis of the notification received from the AP.

In step S54, the AP sets to stop the transmission of the beacon frame from the NIC that enters the sleep period. For example, a setting value of a beacon transmission interval is set to a sufficiently large value.

In step S55, the AP sets to return a rejection response in a case where the STA erroneously sends a transmission request during the sleep period.

### 4. Shortening of Connection Processing Time Associated with Channel Switching Processing

Hereinafter, a method for shortening the connection processing time associated with the channel switching processing will be described.

Before the channel switching processing, the control apparatus 100 controls the plurality of wireless communication apparatuses 10 to execute “connection information sharing processing”. In more detail, the control apparatus 100 controls the plurality of wireless communication apparatuses 10 to share the connection information regarding each of the plurality of NICs in advance. For example, the connection information regarding each NIC includes a switching timing, a network identifier (for example, BSSID), and an allocated channel of the NIC. Then, the plurality of wireless communication apparatuses 10 executes the connection processing of connecting each other via the selected NICs on the basis of the connection information acquired in advance.

As described above, since the connection information regarding each NIC is shared before the channel switching processing, the time required for the connection processing at the time of channel switching is shortened. In particular, after a certain STA is connected to the AP for the first time, the time required for the connection processing when the channel switching processing is performed in the STA for the first time is shortened. As a result, the time required for the channel switching is shortened, and service quality is improved.

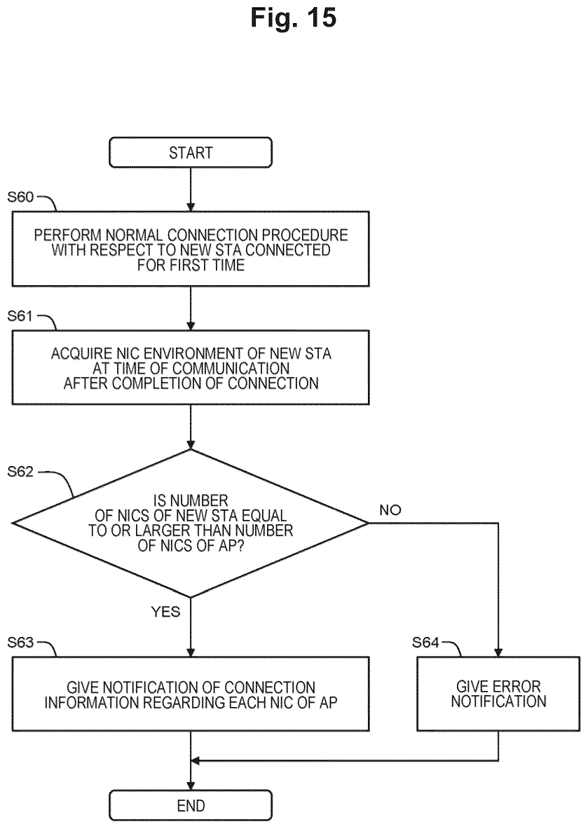

FIG. 15 is a flowchart illustrating an example of the connection information sharing processing.

A new STA to be connected to the AP for the first time will be considered. For a new STA to be connected to the AP for the first time, first, a normal connection procedure is performed (step S60). At this time, the NIC of the same channel as the selected NIC currently used by the AP is used as the selected NIC.

After completion of the connection processing, the AP performs inquiry communication with the new STA. At the time of the inquiry communication, the AP acquires information of the NIC environment of the new STA (step S61). The NIC environment includes the number of NICs included in the STA. The NIC environment may include whether the STA supports the channel switching processing according to the present embodiment. For example, in a case where the STA is capable of using a general-purpose network command such as embedded Linux (registered trademark), the NIC environment can be acquired by using a command such as ifconfig. As another example, the new STA may create and return information of its own NIC environment to the AP in response to the inquiry from the AP.

In subsequent step S62, the AP determines whether the number of NICs of the new STA is equal to or larger than the number of NICs of the AP. In other words, the AP determines whether the number of NICs of the new STA is insufficient with respect to the number of NICs of the AP. In a case where the number of NICs of the new STA is equal to or larger than the number of NICs of the AP, i.e., in a case where the number of NICs of the new STA is not insufficient with respect to the number of NICs of the AP (step S62; Yes), the processing proceeds to step S63. On the other hand, in a case where the number of NICs of the new STA is insufficient with respect to the number of NICs of the AP (step S62; No), the processing proceeds to step S64.

In step S63, the AP notifies the new STA of the connection information regarding each NIC included in the AP. For example, the connection information regarding each NIC includes a switching timing, a network identifier (for example, BSSID), and an allocated channel of the NIC.

In step S64, the AP transmits an error message indicative of insufficiency to the control apparatus 100.

Note that steps S62 and S64 may be omitted.

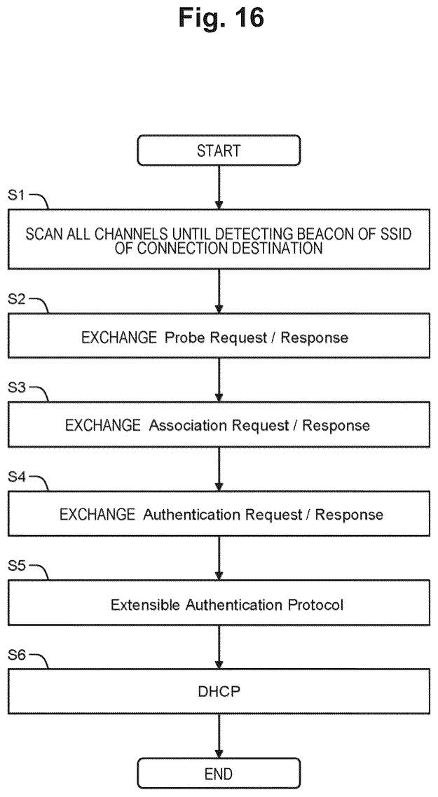

FIG. 16 illustrates general connection processing as a comparative example. First, a STA scans all channels until detecting a beacon including an SSID of a connection destination AP (step S1). Thereafter, the AP and the STA exchange Probe Request/Response frames (step S2), exchange Association Request/Response frames (step S3), and exchange Authentication Request/Response frames (step S4). Further, for communication protection, the AP and the STA exchange security information by Extensible Authentication Protocol (step S5). Thereafter, an IP address is allocated by Dynamic Host Configuration Protocol (DHCP), and a communicable state is obtained (step S6).

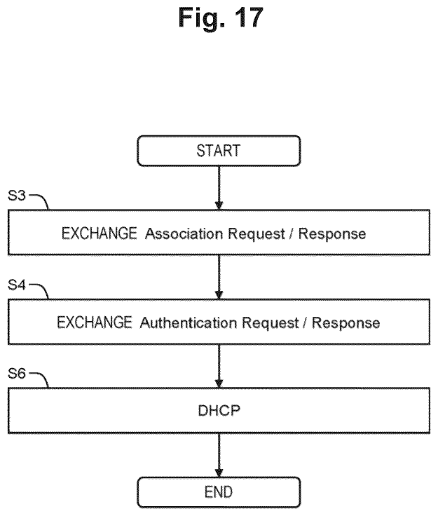

FIG. 17 is a flowchart illustrating an example of the connection processing according to the present embodiment. For example, when the connection information includes the channel information of the NIC to be used next, scanning of the channels is unnecessary, and step S1 can be omitted. In addition, in the case of the same NIC, it is not necessary to exchange the Probe information, and step S2 can be omitted. Step S5 can be omitted by exchanging the security information in advance.

By exchanging the contents of the Association Request/Response frames in advance, step S3 can be omitted, and the connection processing can be further advanced.

In addition, in the case of the comparative example illustrated in FIG. 16, since the transmission rate cannot be adjusted yet at the stage of the connection processing, the lowest rate is used as the transmission rate of the radio frame. On the other hand, according to the present embodiment, the information transmission time in the connection processing can be shortened by giving notification of the optimum rate in advance.

As described above, according to the present embodiment, since the connection information regarding each NIC is shared before the channel switching processing, the time required for the connection processing at the time of channel switching is shortened. In particular, after a certain STA is connected to the AP for the first time, the time required for the connection processing when the channel switching processing is performed in the STA for the first time is shortened. As a result, the time required for the channel switching is shortened, and service quality is improved.

### 5. Handling of Mixed Environment

Not all STAs can support the channel switching processing (NIC switching processing) according to the present embodiment. For example, in a case where the number of NICs of a certain STA is insufficient with respect to the number of NICs of an AP, the NICs cannot always follow the channel switching processing.

A wireless terminal (first wireless terminal) that can completely support the channel switching processing according to the present embodiment is hereinafter referred to as an “STA-X”. On the other hand, a wireless terminal (second wireless terminal) that cannot necessarily support the channel switching processing according to the present embodiment is hereinafter referred to as an “STA-Y”. Hereinafter, processing in a case where the wireless communication system 1 is in a mixed environment including both the STA-X and the STA-Y will be described.

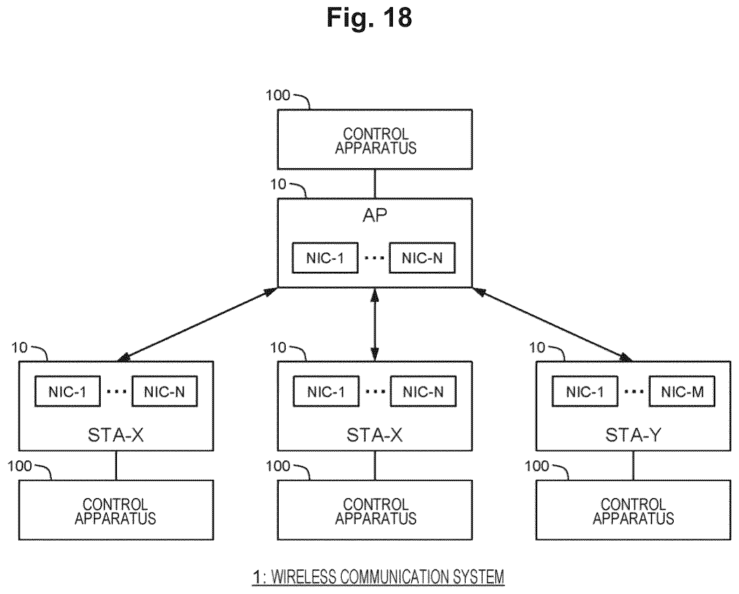

FIG. 18 is a block diagram schematically illustrating a configuration example of the wireless communication system 1 in the case of a mixed environment. The description overlapping with FIG. 1 already described is appropriately omitted. The wireless communication system 1 includes a plurality of wireless communication apparatuses 10 constituting a wireless communication network. The plurality of wireless communication apparatuses 10 includes an AP, one or more STA-Xs, and one or more STA-Ys. The AP and the STA-X include NIC-1 to NIC-N. Herein, N is an integer of 2 or more. On the other hand, the STA-Y includes NIC-1 to NIC-M. Here, M is an integer less than N (M<N). For example, when N is 2 and M is 1, the STA-X is a multi-channel wireless terminal, and the STA-Y is a single-channel wireless terminal.

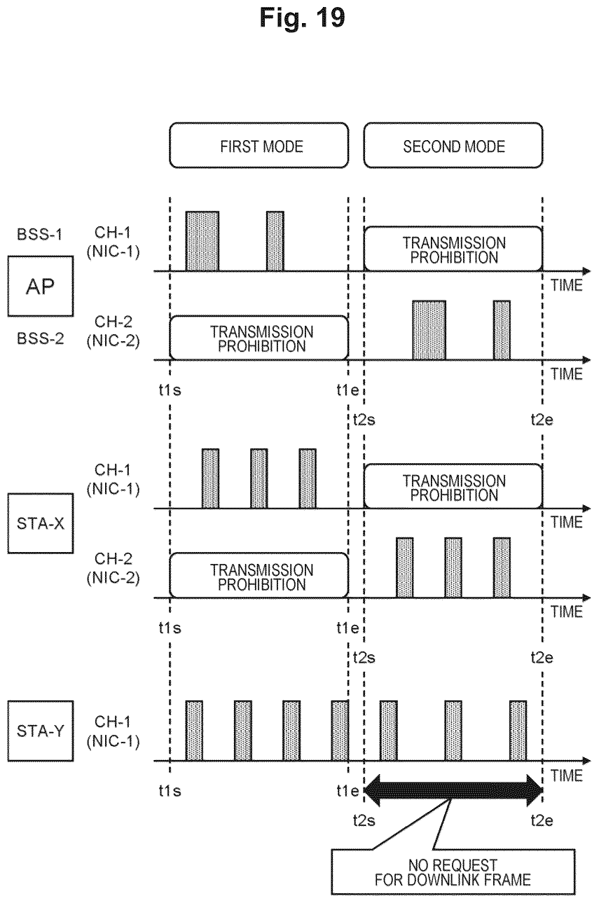

FIG. 19 is a conceptual diagram for describing an example of the channel switching processing in the case of a mixed environment. The description overlapping with FIG. 2 already described is appropriately omitted. The AP and the STA-X include an NIC-1 that performs wireless communication through a first channel CH-1 and an NIC-2 that performs wireless communication through a second channel CH-2 different from the first channel CH-1. On the other hand, the STA-Y includes an NIC-1 that performs wireless communication through a first channel CH-1 but does not include an NIC-2 that performs wireless communication through a second channel CH-2.

The above-described channel switching processing (see Section 1, Section 3) is performed on the AP and the STA-X.

In a first period from time t1s to time t1e, the control apparatus 100 sets a first mode. Specifically, the control apparatus 100 sets the NIC-1 as a selected NIC in each of the AP and the STA-X. The NIC-2 enters the transmission prohibition period.

In a second period from time t2s to time t2e, the control apparatus 100 sets a second mode. Specifically, the control apparatus 100 sets the NIC-2 as a selected NIC in each of the AP and the STA-X. The NIC-1 enters the transmission prohibition period.

Note that, in the transmission prohibition period, data reception is possible, but data transmission is prohibited. As a modification, only transmission of a specific radio frame (for example, a response frame (ACK) in response to reception of an uplink frame) may be allowed even during the transmission prohibition period. For example, when ACK transmission time is not included in the limit of the total transmission time, the transmission of the ACK may be allowed.

On the other hand, the STA-Y is as described below.

The control apparatus 100 controls the STA-Y to communicate with the AP using the NIC-1. In other words, the control apparatus 100 sets the NIC-1 as the selected NIC of the STA-Y. In the first period from time t1s to time t1e, since the AP also uses the NIC-1 as the selected NIC, the AP and the STA-Y can communicate with each other through the first channel CH-1.

However, the channel used for communication in the second period from time t2s to time the is the second channel CH-2. Since the STA-Y does not include the NIC-2 of the second channel CH-2, the STA-Y cannot perform communication through the second channel CH-2. However, when the communication of the STA-Y is completely stopped in the second period, the communication efficiency decreases.

Therefore, according to the present embodiment, the control apparatus 100 controls the STA-Y to execute the “limited communication processing” in the second period. Specifically, the control apparatus 100 controls the STA-Y to continue data transmission using the NIC-1 even in the second period. However, the second period corresponds to the transmission prohibition period of the NIC-1 on the AP side. Therefore, the control apparatus 100 controls the STA-Y so as not to request the AP for all downlink frames in the second period. For example, the STA-Y transmits an uplink frame to the AP with the “NO ACK” policy.

Alternatively, in a case where the transmission of the ACK is allowed even in the transmission prohibition period, the control apparatus 100 may control the STA-Y to request the AP for the ACK but not for the downlink frame other than the ACK.

In general, in a period in which none of NIC-1 to NIC-M included in the STA-Y corresponds to the same channel as the selected NIC of the AP, the control apparatus 100 controls the STA-Y to execute the limited communication processing. In the limited communication processing, the STA-Y does not request the AP for all downlink frames or a downlink frame other than the ACK.

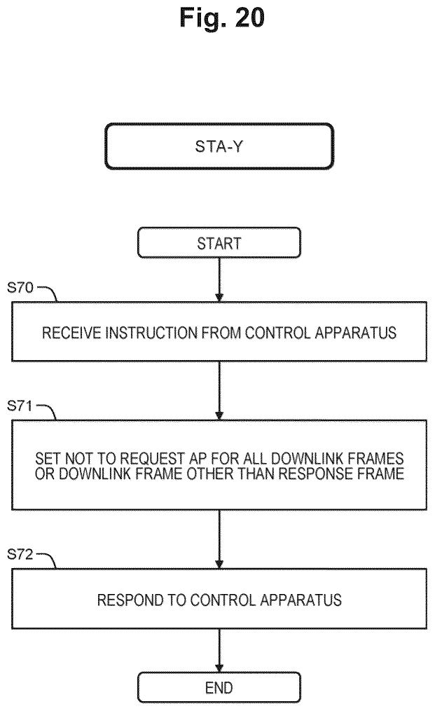

FIG. 20 is a flowchart for describing the limited communication processing. It is assumed that the control apparatus 100 transmits the NIC switching instruction to each STA including the STA-Y (see Section 3, and FIGS. 5, 7, 9, and 13). The STA-Y receives the NIC switching instruction from the control apparatus 100 (step S70). In a case of the instruction of switching to the NIC not supported by the STA-Y, the STA-Y does not switch the NIC to be used. Instead, the STA-Y sets not to request the AP for all downlink frames or a downlink frame other than the ACK (step S71). Then, the STA-Y returns a response to the control apparatus 100 (step S72).

As described above, according to the present embodiment, it is possible to achieve a mixed environment in which the STA-X and the STA-Y are mixed. In addition, even when the NIC on the AP side enters the transmission prohibition period, the communication of the STA-Y can be continued and the communication efficiency can be improved by causing the STA-Y to execute the limited communication processing.

### REFERENCE SIGNS LIST

1 Wireless communication system
10 Wireless communication apparatus
11 Processor
12 Storage apparatus
13 Control program
14 Management information
15 Interface
16 Timer
100 Control apparatus
110 Processor
120 Storage apparatus
130 Control program
140 Management information
150 Interface
160 Timer
AP Base station
NIC Network interface controller
STA Wireless terminal
STA-X First wireless terminal
STA-Y Second wireless terminal

1. A wireless communication system comprising:
a plurality of wireless communication apparatuses which are a part of a a wireless communication network; and
one or a plurality of control apparatuses that controls the plurality of wireless communication apparatuses,
wherein:
each of the plurality of wireless communication apparatuses includes a plurality of network interface controllers that performs wireless communication through different channels that do not overlap each other,
the one or plurality of control apparatuses executes channel switching processing of switching a use state of the plurality of network interface controllers in each of the plurality of wireless communication apparatuses,
the one or plurality of control apparatuses controls the plurality of wireless communication apparatuses to use network interface controllers of a same channel in a same period,
the one or plurality of control apparatuses controls the plurality of wireless communication apparatuses to share connection information regarding each of the plurality of network interface controllers in advance before the channel switching processing, and
the plurality of wireless communication apparatuses is connected to each other via the network interface controllers to be used on the basis of the connection information acquired in advance.

2. The wireless communication system according to claim 1, wherein:
the connection information includes a switching timing, a network identifier, and an allocated channel of each of the plurality of network interface controllers.

3. The wireless communication system according to claim 1, wherein:
the plurality of wireless communication apparatuses includes a base station and a wireless terminal, and
the base station notifies the wireless terminal of the connection information regarding each of the plurality of network interface controllers included in the base station before the channel switching processing.

4. The wireless communication system according to claim 3, wherein:
the base station notifies the wireless terminal of the connection information before the channel switching processing is performed in the wireless terminal for a first time after connection with the wireless terminal is established for a first time.

5. The wireless communication system according to claim 4, wherein:
the base station acquires information of a network interface controller included in the wireless terminal after connection with the wireless terminal is established for a first time, and
when a number of the network interface controllers of the wireless terminal is not insufficient with respect to a number of the plurality of network interface controllers of the base station, the base station notifies the wireless terminal of the connection information.

6. A wireless communication control method for controlling a plurality of wireless communication apparatuses that are a part of a wireless communication network,
each of the plurality of wireless communication apparatuses including a plurality of network interface controllers that performs wireless communication through different channels that do not overlap each other,
the wireless communication control method comprising:
channel switching processing of switching a use state of the plurality of network interface controllers in each of the plurality of wireless communication apparatuses;
processing of controlling the plurality of wireless communication apparatuses to use network interface controllers of a same channel in a same period;
processing of controlling the plurality of wireless communication apparatuses to share connection information regarding each of the plurality of network interface controllers in advance before the channel switching processing; and
processing of connecting the plurality of wireless communication apparatuses to each other via the network interface controllers to be used on the basis of the connection information acquired in advance.

7. A control apparatus for controlling a plurality of wireless communication apparatuses that are part of a wireless communication network,
each of the plurality of wireless communication apparatuses including a plurality of network interface controllers that performs wireless communication through different channels that do not overlap each other,
the control apparatus comprising: a processor and a memory connected to the processor,
wherein:
the processor executes channel switching processing of switching a use state of the plurality of network interface controllers in each of the plurality of wireless communication apparatuses,
the processor controls the plurality of wireless communication apparatuses to use network interface controllers of a same channel in a same period,
the processor controls the plurality of wireless communication apparatuses to share connection information regarding each of the plurality of network interface controllers in advance before the channel switching processing, and
the plurality of wireless communication apparatuses is connected to each other via the network interface controllers to be used on the basis of the connection information acquired in advance.

8. A non-transitory computer readable medium storing a control program that is executed by a computer and causes the computer to perform the method of claim 6.
